(19) United States
(12) Patent Application Publication
(10) Pub. No.: US 2010/0328640 A1
(43) Pub. Date: Dec. 30, 2010

(54) POLARIZATION STATE MEASUREMENT APPARATUS AND EXPOSURE APPARATUS

(75) Inventor: Takanori UEMURA, Utsunomiya-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/827,339

(22) Filed: Jun. 30, 2010

(30) Foreign Application Priority Data
Jun. 30, 2009 (JP) 2009-156323

(51) Int. Cl. G03B 27/72; G01J 4/00

(52) U.S. Cl. 355/71; 702/189; 356/364

(57) ABSTRACT

A measurement apparatus for measuring the polarization state of a light beam Fourier-transforms changes in intensity of a plurality of light beams with different polarization states, which are detected while changing a relative rotation angle θ between the waveplate and the polarizer about the optical axis, to calculate the values of first Fourier coefficients of respective components oscillating with waveforms described by cos 4θ, sin 4θ, sin 2θ, and cos 2θ, approximately calculates, using the values of the first Fourier coefficients, third coefficients that define the relationship between the first Fourier coefficients and second Fourier coefficients of the respective components oscillating with waveforms described by cos 4θ, sin 4θ, and sin 2θ assuming that the detection result contains no measurement error attributed to the optical system, and calculates a measurement error attributed to the optical system using the third coefficients.

### BACKGROUND OF THE INVENTION

1. Field of the Invention

The present invention relates to a measurement apparatus that measures the polarization state of a light beam to be measured, and an exposure apparatus.

2. Description of the Related Art

A projection exposure apparatus which projects and transfers a circuit pattern drawn on a mask such as a reticle onto, for example, a wafer by a projection optical system has conventionally been employed to manufacture semiconductor devices using photolithography. Three important factors: resolution, overlay accuracy, and throughput determine the exposure performance of a projection exposure apparatus. In recent years, a technique for increasing the NA (Numerical Aperture) of a projection optical system by immersing it in a liquid is attracting a great deal of attention to improve resolution especially among these three factors. Increasing the NA of a projection optical system amounts to widening the angle between a normal to the image plane and the direction in which the incident light travels, and imaging which exploits this mechanism is called high-NA imaging.

The polarization state of exposure light is an important factor in high-NA imaging. For example, a case in which a so-called line-and-space (L&S) pattern having repetitive lines and spaces is formed by exposure will be considered. An L&S pattern is formed by two-beam interference of plane waves. A plane including two-beam incident direction vectors is defined as the incident plane, polarized light perpendicular to the incident plane is defined as S-polarized light, and polarized light parallel to the incident plane is defined as P-polarized light. When the two-beam incident direction vectors are orthogonal to each other, S-polarized light interferes, so it forms a light intensity distribution corresponding to the L&S pattern on the image plane. In contrast, P-polarized light does not interfere and therefore has a constant light intensity distribution, so it never forms a light intensity distribution corresponding to the L&S pattern on the image plane. Assume that S-polarized light and P-polarized light mix with each other. In this case, a light intensity distribution with a contrast lower than that of a light intensity distribution formed by only S-polarized light is formed on the image plane. As the ratio of P-polarized light increases, the contrast of the light intensity distribution on the image plane lowers and, ultimately, no pattern is formed. To prevent this, it is necessary to improve the contrast by controlling the polarization state of exposure light. Because the exposure light with its polarization state controlled can form a light intensity distribution with sufficiently high contrast on the image plane, a finer pattern can be formed by exposure.

An illumination optical system mainly controls the polarization state of exposure light. Polarized illumination needs to have a shape effective for a certain pattern and an optimum polarization direction. For example, X-dipole illumination whose polarization direction is the Y direction is effective for a pattern in the Y direction. Also, annular illumination, which uses tangential polarization whose polarization direction is the circumferential direction of an annular zone, is effective for a mixture of patterns in various directions. However, even when exposure light has its polarization state controlled at a certain position in the illumination optical system, it reaches the exposure position in a polarization state different from that attained by the control, due to an influence that optical members downstream of the certain position exert on the polarization state. For example, note that an antireflection coating is typically formed on a lens to improve its transmittance and a high reflective coating is typically formed on a mirror to improve its reflectance. These coatings account for a change in polarization state because they have reflectances that change depending on the polarization direction and therefore generate phase differences between orthogonal polarized light beams. Note also that as the wavelength of exposure light shortens, crystalline members such as quartz or fluorite are used for glass materials. These glass materials change the polarization state because they have stress birefringences due to strain generated in the process of manufacturing them. Furthermore, because the birefringence of a lens changes in response to a stress acting upon holding it by a member such as a lens barrel, it is very difficult to always maintain the lens birefringence constant. This makes it necessary to measure the polarization state of an exposure apparatus. As one example, Japanese Patent Laid-Open No. 2007-59566 proposes a measurement apparatus that measures the polarization states of an illumination optical system and projection optical system using the method utilizing a rotating waveplate.

Unfortunately, a measurement apparatus which measures the polarization state using the method utilizing a rotating waveplate has manufacturing errors with respect to design values, which influence the measurement result. To measure the polarization state of light with high accuracy, it is necessary to correct the measurement result by taking account of the manufacturing errors of the measurement apparatus. To correct a retardation error of a waveplate and an error of the extinction ratio of a polarizer, Japanese Patent Laid-Open No. 2006-179660 proposes a method of measuring the optical characteristics of the waveplate and polarizer in advance, and correcting the measurement result using the obtained measurement values of these optical characteristics.

A measurement apparatus which measures the polarization state has manufacturing errors other than a retardation error of a waveplate and an error of the extinction ratio of a polarizer. For example, a stress is produced upon holding a lens barrel by a polarizer, and this generates birefringence in the polarizer. Also, when a birefringent crystal such as a Rochon prism is adopted as a polarizer, the tilt of the polarizer influences the polarization state of light. Moreover, unless the relative rotation origin position between the fast axis of a waveplate and the transmission axis of a polarizer about the optical axis is set with sufficiently high accuracy, the polarization state cannot be correctly measured. Because the prior arts do not take account of the influence of these factors, they cannot measure the polarization state of light with high accuracy.

### SUMMARY OF THE INVENTION

The present invention has been made in consideration of the above-described problems, and provides a measurement apparatus which can measure the polarization state of a light beam to be measured with high accuracy by reducing an influence that manufacturing errors of the measurement apparatus exert on the measurement result.

According to the present invention, there is provided a measurement apparatus which comprises an optical system including a waveplate that changes a polarization state of light, and a polarizer that selectively transmits a specific polarization component of the light having passed through the waveplate, a detector that detects an intensity of the light having passed through the waveplate and the polarizer, and a calculator, and which measures a polarization state of a light beam to be measured that is incident on the optical system, wherein the calculator is configured to Fourier-transform changes in intensity of a plurality of light beams with different polarization states, which are detected by the detector while changing a relative rotation angle θ between the waveplate and the polarizer about an optical axis, to calculate values of a plurality of Fourier coefficients that are coefficients of respective components oscillating with waveforms described by cos 4θ, sin 4θ, sin 2θ, and cos 2θ, approximately calculate, using the values of the first Fourier coefficients, a plurality of third coefficients that are coefficients which define a relationship between the plurality of first Fourier coefficients and a plurality of second Fourier coefficients that are coefficients of the respective components oscillating with waveforms described by cos 4θ, sin 4θ, and sin 2θ in a Fourier transform of a change in intensity of light, which is detected by the detector while changing a relative rotation angle between the waveplate and the polarizer about the optical axis assuming that the detection result contains no measurement error attributed to the optical system, and calculate a measurement error attributed to the optical system using the plurality of third coefficients, the plurality of third coefficients include not less than two independent coefficients independent of each other, and a dependent coefficient determined by a combination of the not less than two independent coefficients, and in a relation which defines a relationship between the first Fourier coefficient of the component oscillating with a waveform described by cos 2θ and the plurality of second Fourier coefficients, the calculator substitutes a value of the first Fourier coefficient of the component oscillating with a waveform described by cos 2θ, calculated for each of the plurality of light beams, for the first Fourier coefficient of the component oscillating with a waveform described by cos 2θ, and substitutes values of the first Fourier coefficients of the components oscillating with respective oscillation periods, calculated for each of the plurality of light beams, for the plurality of second Fourier coefficients of the components oscillating with the corresponding oscillation periods to calculate the not less than two independent coefficients, and calculates the dependent coefficient from the not less than two calculated independent coefficients.

Further features of the present invention will become apparent from the following description of exemplary embodiments with reference to the attached drawings.

### BRIEF DESCRIPTION OF THE DRAWINGS

FIG. 1 is a schematic sectional view showing the arrangement of an exposure apparatus;

FIG. 2 is a partial sectional view showing the state in which an optical unit is placed on a reticle stage;

FIG. 3 is a graph showing a retardation that occurs when a polarizer has a tilt;

FIG. 4 is a flowchart for correcting the measurement result in the first embodiment;

FIGS. 5A and 5B are views showing the measurement results obtained when a measurement apparatus has and does not have a manufacturing error;

FIGS. 6A to 6C are views showing the correction results when repeated calculation is done once in the flowchart shown in FIG. 4;

FIGS. 7A to 7C are views showing the correction results when repeated calculation is done twice in the flowchart shown in FIG. 4; and

FIG. 8 is a flowchart for correcting the measurement result in the second embodiment.

### DESCRIPTION OF THE EMBODIMENTS

Embodiments of the present invention will be described below with reference to the accompanying drawings. Note that the same reference numerals denote the same members throughout the drawings, and a repetitive description thereof will not be given.

### First Embodiment

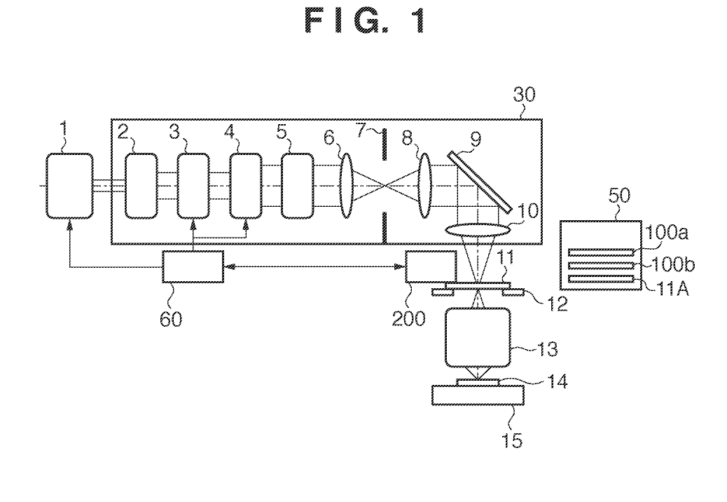

Referring to FIG. 1, an exposure apparatus according to the first embodiment includes a light source 1 for emitting exposure light (illumination light). The light source 1 can be, for example, an ArF excimer laser light source which emits light with a wavelength of about 193 nm or a KrF excimer laser light source which emits light with a wavelength of about 248 nm. A nearly collimated light beam emitted by the light source 1 is shaped into a light beam with a rectangular cross-section via a beam guiding system 2, and is incident on a polarization state changer 3. The beam guiding system 2 has a function of guiding the incident light beam to the polarization state changer 3 while converting it into a light beam with an appropriate size and an appropriate cross-sectional shape, and actively correcting fluctuations in position and angle of the light beam which is incident on the polarization state changer 3 in the subsequent stage. On the other hand, the polarization state changer 3 has a function of adjusting the polarization state of light which illuminates a reticle 11 (to be described later; and, eventually, a wafer 14). More specifically, the polarization state changer 3 converts the incident linearly polarized light into linearly polarized light with a different oscillation direction, converts the incident linearly polarized light into non-polarized light, or outputs the incident linearly polarized light intact without conversion.

The light beam having its polarization state converted as needed by the polarization state changer 3 is incident on a micro fly-eye lens (or a fly-eye lens) 5 via a beam shape changer 4. The beam shape changer 4 includes, for example, a diffractive optical element, scaling optical system, and prism. The beam shape changer 4 has a function of changing the size and shape of an irradiation field formed on the incident surface of the micro fly-eye lens 5, and, eventually, those of a surface light source (to be referred to as an “effective light source” hereinafter) formed on the back focal plane (illumination pupil plane) of the micro fly-eye lens 5. The micro fly-eye lens 5 is, for example, a wavefront splitting type optical integrator including a large number of microlenses which have different positive refractive powers and are two-dimensionally densely arrayed. A diffractive optical element or an optical integrator such as a prismatic rod integrator can also be adopted in place of the micro fly-eye lens 5. The incident light beam on the micro fly-eye lens 5 has its wavefront two-dimensionally split by the large number of microlenses, and the light beams obtained by the wavefront splitting are converged on the back focal planes of the respective microlenses. In this way, a virtual surface light source (to be referred to as a “secondary light source” hereinafter) including a large number of light sources is formed on the back focal plane of the micro fly-eye lens 5. The light beam from the secondary light source formed on the back focal plane of the micro fly-eye lens 5 superposedly illuminates a traveling field stop 7 via a condenser optical system 6.

In this way, a rectangular illumination field corresponding to the shapes and focal lengths of the respective microlenses which constitute the micro fly-eye lens 5 is formed on the traveling field stop 7. The light beam having passed through the rectangular aperture (light-transmitting portion) of the traveling field stop 7 illuminates the reticle (mask) 11, on which a predetermined pattern is formed, after passing through a lens 8, mirror 9, and lens 10. That is, an image of the rectangular aperture of the traveling field stop 7 is formed on the reticle 11. The reticle 11 is held by a reticle stage 12. The reticle 11 has a pattern formed on its lower surface. Light diffracted by the pattern forms an image on the wafer 14, placed on a wafer stage 15, via a projection optical system 13. In this way, full-field exposure or scanning exposure is performed while performing two-dimensional driving control of the wafer 14 within a plane perpendicular to the optical axis of the projection optical system 13, thereby sequentially transferring by exposure the pattern of the reticle 11 to each exposure region on the wafer 14. The wafer 14 is coated with a photoresist.

The exposure apparatus includes a reticle stocker 50. The reticle stocker 50 stores a reticle 11a having a pattern different from that of the reticle 11, and optical units 100a and 100b (to be described later). The exposure apparatus can exchange the reticle 11 placed on the reticle stage 12 for the reticle 11a or the optical unit 100a or 100b stored in the reticle stocker 50 via a reticle exchange unit (not shown) in accordance with the exposure process. The optical unit 100 includes, for example, a plurality of optical elements, as will be described later. The optical unit 100 is used to measure the individual optical characteristics of an illumination optical system 30 and the projection optical system 13, and their overall optical characteristics. The optical unit 100 has roughly the same shape as that of the reticle 11 and can be placed on the reticle stage 12 of the exposure apparatus, like the reticle 11. Note that the optical unit 100 is stored in the reticle stocker 50 in FIG. 1.

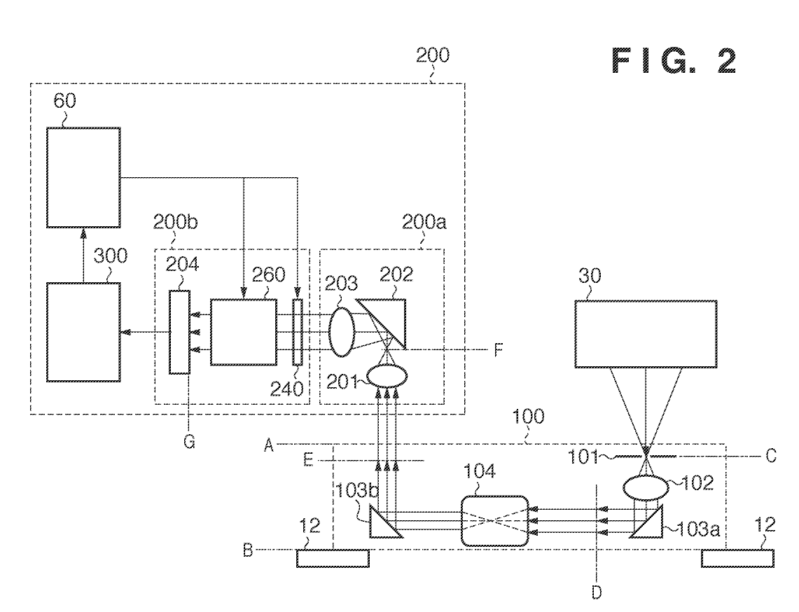

The detailed arrangement of the optical unit 100 and measurement of the polarization state of the illumination optical system 30 using the optical unit 100 and a measurement apparatus 200 will be described with reference to FIG. 2. Referring to FIG. 2, the optical unit 100 is placed on the reticle stage 12, and a position corresponding to the upper surface of the reticle 11 is shown as a plane A (alternate long and two short dashed line), whereas that corresponding to the lower surface of the reticle 11 is shown as a plane B (alternate long and two short dashed line). In a normal reticle 11, the plane A corresponds to the position of a blank surface, whereas the plane B corresponds to the position of a pellicle surface attached to the reticle 11. The optical unit 100 includes optical elements. More specifically, the optical unit 100 includes a pinhole 101, a Fourier transform lens 102, deflecting mirrors 103a and 103b, and a relay optical system 104. The optical unit 100 has its upper surface roughly located at the position of the plane A, and its lower surface roughly located at the position of the plane B so as to be automatically loaded into and unloaded from the exposure apparatus (that is, so as to be placed on the reticle stage 12). However, the optical unit 100 may have its upper surface located at a position slightly shifted from the plane A in the vertical direction, and its lower surface located at a position slightly shifted from the plane B in the vertical direction as long as it can be automatically loaded into and unloaded from the exposure apparatus.

Measurement of the polarization optical characteristics (polarization state) of the illumination optical system 30 while the optical unit 100 is placed on the reticle stage 12 will be described. The illumination optical system 30 illuminates a plane C, as shown in FIG. 2. The plane C is located at a position corresponding to the pattern surface of the reticle 11. As described above, the optical unit 100 includes the pinhole 101, which can be positioned in the plane C. This is because if the pinhole 101 is defocused from the plane C, it cannot capture a certain component of light from the effective light source in the periphery of the illumination region of the illumination optical system 30. The light beam having passed through the pinhole 101 is converted into a nearly collimated light beam by the Fourier transform lens 102. The light beam (collimated light beam) having passed through the Fourier transform lens 102 is reflected (deflected) by the deflecting mirror 103a to form an image of the effective light source distribution of the illumination optical system 30 on a plane D. Note that the plane D serves as the pupil plane for the plane C serving as the image plane. The image of the effective light source distribution formed on the plane D is formed again on a plane E via the relay optical system 104 and deflecting mirror 103b. Note that the plane E serves as the observation plane of the measurement apparatus 200 (to be described later), and optically corresponds to the pattern surface of the reticle 11, like the plane C. The relay optical system 104 can serve as an optical system telecentric on both the incident side (on the side of the plane D) and the exit side (on the side of the plane E). When the relay optical system 104 serves as a telecentric optical system, it is possible to minimize an imaging magnification error on the plane E attributed to an allowable manufacturing error of, for example, an optical element which constitutes the relay optical system 104. The configuration of the relay optical system 104 is generally known as a beam expander.

The measurement apparatus 200 includes a relay unit 200a closer to the light source 1 than a waveplate 240, and a measurement unit 200b closer to a detector 204 than the waveplate 240. The measurement apparatus 200 measures the image of the effective light source distribution formed on the plane E. The image of the effective light source distribution formed on the plane E is incident on an objective lens 201 and becomes a light beam converged on a pupil plane F of the objective lens 201 in the measurement apparatus 200. The light beam (converged light beam) having passed through the objective lens 201 is reflected (deflected) by a deflecting mirror 202 and converted into a collimated light beam via a lens 203. The light beam (collimated light beam) having passed through the lens 203 forms an image of the effective light source distribution on a plane G. Note that an optical system including the objective lens 201 and lens 203 can serve as an optical system telecentric on both the incident side (on the side of the plane E) and the exit side (on the side of the plane G) for the same reason as in the relay optical system 104 described earlier.

The detector 204 is, for example, a two-dimensional image detection element such as a CCD. The detector 204 is placed on the plane G, and detects (observes) the image of the effective light source distribution formed via the objective lens 201, deflecting mirror 202, and lens 203. The waveplate 240 and a polarizer 260 are inserted between the lens 203 and the detector 204. The waveplate 240 imparts birefringence to the transmitted light by changing its polarization state. The polarizer 260 selectively transmits a specific polarization component having passed through the waveplate 240. As shown in FIG. 2, the waveplate 240 and polarizer 260 are arranged in this order from the incident side. The measurement apparatus 200 measures the polarization state of a light beam to be measured, which is incident on an optical system including the waveplate 240 and polarizer 260. The waveplate 240 is, for example, a λ/4 plate made of magnesium fluoride. Also, the polarizer 260 is, for example, a PBS (Polarizing Beam Splitter) or a Rochon prism. The waveplate 240 can rotate about the optical axis as the center upon being actuated by a driving unit 60, and has a function of changing the relative rotation angle between the waveplate 240 and the polarizer 260 about the optical axis. The information concerning the rotation angle of the waveplate 240 from the driving unit 60, and the detection result from the detector 204 are provided to a calculator 300.

In this manner, unless the incident light on the detector 204 is non-polarized light, the light intensity distribution on the detection surface of the detector 204 changes upon rotating the waveplate 240 about the optical axis via the driving unit 60. The measurement apparatus 200 detects a change in light intensity distribution using the detector 204 while rotating the waveplate 240 about the optical axis using the driving unit 60. Based on the rotation angle information from the driving unit 60 and the information of a change in light intensity distribution from the detector 204, the calculator 300 calculates the polarization state of the illumination light using the method utilizing a rotating waveplate.

The principle of the method utilizing a rotating waveplate will be described below. As the waveplate 240 rotates, the light intensity detected by each pixel of the detector 204 changes in accordance with a predetermined periodic function. The method utilizing a rotating waveplate can calculate the polarization state of the incident light by analyzing the periodic function.

One method represents the polarization state of light using Jones vectors and Jones matrices. If an influence that the measurement apparatus 200 and optical unit 100 exert on the polarization is not taken into consideration, a Jones vector j₀ describing the polarization state of light on the detection surface of the detector 204 is given by:

j₀=JₚₒₗJᵣₑₜj_{sys} (1)

where Jₚₒₗ is the Jones matrix of the polarizer 260, Jᵣₑₜ is the Jones matrix of the waveplate 240, and j_{sys} is the Jones vector describing the polarization state of the exit light from the illumination optical system 30.

In contrast to this, if manufacturing errors of the measurement apparatus 200 and optical unit 100 with respect to design values are taken into consideration, a Jones vector j₀ on the detection surface of the detector 204 is given by:

j₀=JₚₒₗJₑᵣᵣJᵣₑₜJᵣₑₗJᵤₙᵢj_{sys} (2)

where Jₑᵣᵣ is the Jones matrix describing a manufacturing error of the measurement unit 200b, Jᵣₑₗ is the Jones matrix describing a manufacturing error of the relay unit 200a, and Jᵤₙᵢ is the Jones matrix describing a manufacturing error of the optical unit 100.

Japanese Patent Laid-Open No. 2007-59566 describes details of a method of measuring the Jones matrix Jᵣₑₗ describing a manufacturing error of the relay unit 200a and the Jones matrix Jᵤₙᵢ describing a manufacturing error of the optical unit 100, and correcting their influence. More specifically, Jones matrices attributed to these manufacturing errors can be calculated by guiding three light beams with known polarization states to the respective units and measuring the polarization states of the exit light beams from them. Thus, a Jones vector jᵢ describing the incident light on the measurement unit 200b is given by:

$${j}_{i} = {J}_{rel} {J}_{uni} {j}_{sys} = ( \begin{matrix}{A}_{x} \\ {A}_{y} {e}^{iδ}\end{matrix} ) \qquad ( 3 )$$

Substituting equation (3) into equation (2) yields:

j₀=JₚₒₗJₑᵣᵣJᵣₑₜjᵢ (4)

When the Jones vector jᵢ describing the incident light on the measurement unit 200b can be obtained, the Jones vector j_{sys} describing the exit light from the illumination optical system 30 can be calculated using equation (3). Hence, to obtain the Jones vector j_{sys} describing the exit light from the illumination optical system 30, the Jones vector jᵢ describing the incident light on the measurement unit 200b need only be measured.

The Jones matrix Jₑᵣᵣ attributed to a manufacturing error of the measurement unit 200b is given by:

$${J}_{err} = ( \begin{matrix}{J}_{11} & {J}_{12} \\ {J}_{21} & {J}_{22}\end{matrix} ) \qquad ( 5 )$$

One example of a manufacturing error associated with the measurement unit 200b is an error attributed to the tilt of the polarizer 260 with respect to the optical axis of the waveplate 240 and polarizer 260. When a Rochon prism is adopted as the polarizer 260, the incident-side crystal axis desirably runs parallel to the optical axis. However, in practice, it is difficult to make the crystal axis precisely parallel to the optical axis. At this time, light obliquely cuts across an index ellipsoid and the incident light on it experiences birefringence. When the crystal axis of the polarizer has a sufficiently small tilt Θ with respect to the optical axis, sin θ≈θ. Then, a retardation Δ is given by:

$$Δ = \frac{2 π}{λ} d \frac{{n}_{o}^{2} - {n}_{e}^{2}}{2 {n}_{o}^{2} {n}_{o}} {Θ}^{2} \qquad ( 6 )$$

where λ is the light wavelength, d is the crystal thickness, nₒ is the refractive index of the crystal for an ordinary ray, and nₑ is the refractive index of the crystal for an extraordinary ray.

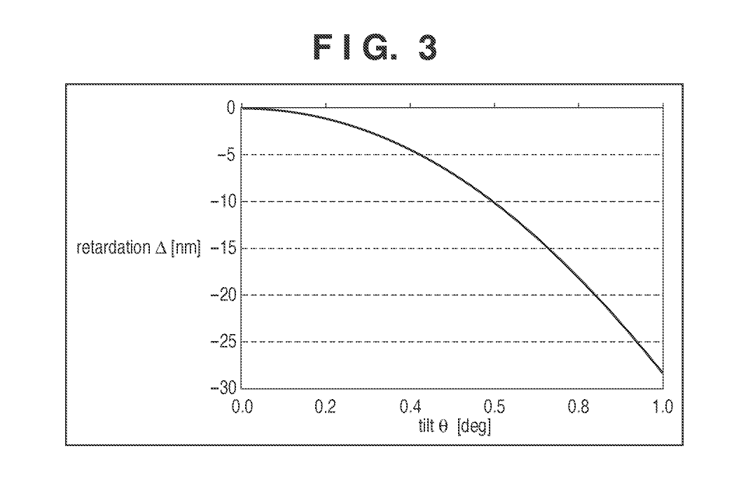

For example, rock crystal has a refractive index of 1.661 for an ordinary ray with a wavelength of 193 nm and a refractive index of 1.674 for an extraordinary ray with a wavelength of 193 nm. FIG. 3 is a graph obtained by plotting the retardation Δ that has occurred in 20-mm thick rock crystal as a function of the tilt Θ of the crystal axis of the polarizer with respect to the optical axis. As can be seen from FIG. 3, for example, a retardation of 7.1 nm occurs when the crystal axis of the polarizer tilts by 0.5° with respect to the optical axis.

Another example of a manufacturing error associated with the measurement unit 200b is a measurement error attributed to stress birefringence generated upon holding the polarizer 260. Still another example of a manufacturing error associated with the measurement unit 200b is a measurement error attributed to the birefringence of a glass material which forms the polarizer 260. The Jones matrix Jₑᵣᵣ describing a manufacturing error of the measurement unit 200b is given by:

$${J}_{err} = ( \begin{matrix}cos ( \frac{Δ}{2} ) - i sin ( \frac{Δ}{2} ) cos 2 β & - i sin ( \frac{Δ}{2} ) sin 2 β \\ - i sin ( \frac{Δ}{2} ) sin 2 β & cos ( \frac{Δ}{2} ) + i sin ( \frac{Δ}{2} ) cos 2 β\end{matrix} ) \qquad ( 7 )$$

where Δ is the retardation that occurs due to the above-mentioned errors, and β is the fast axis of the retardation.

For the sake of simplicity, a case in which the waveplate 240 is an ideal λ/4 plate and the polarizer 260 is an ideal polarizer with an extinction ratio of 100% will be considered hereinafter. However, basically the same principle applies even to a case in which the waveplate 240 has a retardation different from λ/4 and a case in which the polarizer 260 has an extinction ratio other than 100%, except that the foregoing equations become complicated in these cases. The Jones matrix of the waveplate 240 is given by:

$${J}_{ret} = \frac{1}{\sqrt{2}} ( \begin{matrix}1 - cos 2 θ & - i sin 2 θ \\ - i sin 2 θ & 1 + cos 2 θ\end{matrix} ) \qquad ( 8 )$$

where θ is the relative rotation angle between the waveplate 240 and the polarizer 260 about the optical axis.

The Jones matrix of the polarizer 260 is given by:

$${J}_{pol} = ( \begin{matrix}1 & 0 \\ 0 & 0\end{matrix} ) \qquad ( 9 )$$

Substituting equations (5), (8), and (9) into equation (4) yields:

$${j}_{0} = \frac{1}{\sqrt{2}} ( \begin{matrix}{J}_{11} \{ {A}_{x} - i {A}_{x} cos 2 θ - {iA}_{y} {e}^{i δ} sin 2 θ \} + {J}_{12} \{ - {iA}_{x} sin 2 θ + {A}_{y} {e}^{iδ} + {iA}_{y} {e}^{i δ} cos 2 θ \} \\ 0\end{matrix} ) \qquad ( 10 )$$

Letting θ be the rotation angle of the waveplate 240 relative to the polarizer 260 about the optical axis, a light intensity I(θ) detected by the detector 204 is given by the inner product of the Jones vector j₀ on the detection surface of the detector 204 and its complex conjugate j₀*:

$$\begin{matrix}\begin{matrix}I ( θ ) = {J}_{0}^{*} \cdot {J}_{0} \\ = \frac{1}{2} {\vert {J}_{11} \vert}^{2} \{ {S}_{0} + \frac{1}{2} {S}_{1} \} + \frac{1}{2} Re [ {J}_{11} {J}_{12}^{*} ] {S}_{2} + \\ \frac{1}{2} {\vert {J}_{12} \vert}^{2} \{ {S}_{0} - \frac{1}{2} {S}_{1} \} + \\ \frac{1}{4} \{ {\vert {J}_{11} \vert}^{2} {S}_{1} - 2 Re [ {J}_{11} {J}_{12}^{*} ] {S}_{2} + {\vert {J}_{12} \vert}^{2} {S}_{1} \} cos 4 θ + \\ \frac{1}{4} \{ {\vert {J}_{11} \vert}^{2} {S}_{2} + 2 Re [ {J}_{11} {J}_{12}^{*} ] {S}_{1} - {\vert {J}_{12} \vert}^{2} {S}_{2} \} sin 4 θ + \\ \frac{1}{2} \{ {\vert {J}_{11} \vert}^{2} {S}_{3} - 2 Im [ {J}_{11} {J}_{12}^{*} ] {S}_{1} - {\vert {J}_{12} \vert}^{2} {S}_{3} \} sin 2 θ + \\ \frac{1}{2} \{ - 2 Re [ {J}_{11} {J}_{12}^{*} ] {S}_{3} + 2 Im [ {J}_{11} {J}_{12}^{*} ] {S}_{2} \} cos 2 θ \\ = \frac{1}{2} {S}_{0}^{′} + \frac{1}{4} {S}_{1}^{′} + \frac{1}{4} {S}_{1}^{′} cos 4 θ + \frac{1}{4} {S}_{2}^{′} sin 4 θ + \\ \frac{1}{2} {S}_{3}^{′} sin 2 θ + \frac{1}{2} {S}_{4}^{′} cos 2 θ\end{matrix} & ( 11 ) \\ for \\ {S}_{0} = {\vert {A}_{x} \vert}^{2} + {\vert {A}_{y} \vert}^{2} \\ {S}_{1} = {\vert {A}_{x} \vert}^{2} - {\vert {A}_{y} \vert}^{2} \\ {S}_{2} = 2 {A}_{x} {A}_{y} cos δ \\ {S}_{3} = 2 {A}_{x} {A}_{y} sin δ \\ {S}_{0}^{′} = {S}_{0} + 2 Re [ {J}_{11} {J}_{12}^{*} ] {S}_{0}^{′} = {S}_{0} + 2 Re [ {J}_{11} {J}_{12}^{*} ] \\ {S}_{1}^{′} = \{ {\vert {J}_{11} \vert}^{2} {S}_{1} - 2 Re [ {J}_{11} {J}_{12}^{*} ] {S}_{2} + {\vert {J}_{12} \vert}^{2} {S}_{1} \} \\ {S}_{2}^{′} = \{ {\vert {J}_{11} \vert}^{2} {S}_{2} + 2 Re [ {J}_{11} {J}_{12}^{*} ] {S}_{1} - {\vert {J}_{12} \vert}^{2} {S}_{2} \} \\ {S}_{3}^{′} = \{ {\vert {J}_{11} \vert}^{2} {S}_{3} - 2 Im [ {J}_{11} {J}_{12}^{*} ] {S}_{1} - {\vert {J}_{12} \vert}^{2} {S}_{3} \} \\ {S}_{4}^{′} = \{ - 2 Re [ {J}_{11} {J}_{12}^{*} ] {S}_{3} + 2 Im [ {J}_{11} {J}_{12}^{*} ] {S}_{2} \} & \end{matrix}$$

As can be seen from equation (11), unless the incident light beam on the detector 204 is non-polarized light, the light intensity detected by each pixel of the detector 204 changes depending on the relative rotation angle θ between the waveplate 240 and the polarizer 260 about the optical axis. Information concerning the polarization state of the incident light beam can be obtained by analyzing the change in light intensity (signal).

If the measurement unit 200b has no manufacturing error, a signal I(θ) detected by the detector 204 is described by:

$$I ( θ ) = \frac{1}{2} {S}_{0} + \frac{1}{4} {S}_{1} + \frac{1}{4} {S}_{1} cos 4 θ + \frac{1}{4} {S}_{2} sin 4 θ + \frac{1}{2} {S}_{3} sin 2 θ \qquad ( 12 )$$

As can be seen from a comparison between equations (11) and (12), when a manufacturing error of the measurement unit 200b is taken into consideration, a component oscillating with a waveform described by cos 2θ is added to the signal upon relatively rotating the waveplate 240 and polarizer 260 about the optical axis. If the measurement unit 200b has no manufacturing error, the Stokes parameters S₀, S₁, S₂, and S₃ describing the polarization state of the incident light can be obtained by Fourier-transforming the signal described by equation (12) to obtain the coefficients of cos 4θ, sin 4θ, and sin 2θ. The Stokes parameters S₀ to S₃ are a plurality of second Fourier coefficients of the Fourier transform of a change in light intensity detected by the detector 204 while changing the rotation angle θ of the polarizer 260 assuming that the detection result contains no measurement error attributed to the measurement unit 200b. The plurality of second Fourier coefficients S₀ to S₃ are the coefficients of a non-oscillating component and components oscillating with waveforms described by cos 4θ, sin 4θ, and sin 2θ, respectively. In contrast, if the measurement unit 200b has a manufacturing error, the Stokes parameters S₀ to S₃ cannot be obtained only by Fourier-transforming the signal described by equation (11). That is, the Stokes parameters S₀ to S₃ cannot be obtained with high accuracy unless correct information concerning a manufacturing error attributed to the measurement unit 200b is known.

The Stokes parameters S₀, S₁, S₂, and S₃ are transformed into Stokes parameters S₀′, S₁′, S₂′, and S₃′, that are a plurality of first Fourier coefficients obtained by Fourier transforming a change in light intensity detected by the detector 204, as:

$$\begin{matrix}{S}^{′} = ( \begin{matrix}{S}_{0}^{′} \\ {S}_{1}^{′} \\ {S}_{2}^{′} \\ {S}_{3}^{′}\end{matrix} ) \\ = ( \begin{matrix}1 & 0 & 2 Re [ {J}_{11} {J}_{12}^{*} ] & 0 \\ 0 & {\vert {J}_{11} \vert}^{2} - {\vert {J}_{12} \vert}^{2} & - 2 Re [ {J}_{11} {J}_{12}^{*} ] & 0 \\ 0 & 2 Re [ {J}_{11} {J}_{12}^{*} ] & {\vert {J}_{11} \vert}^{2} - {\vert {J}_{12} \vert}^{2} & 0 \\ 0 & - 2 Im [ {J}_{11} {J}_{12}^{*} ] & 0 & {\vert {J}_{11} \vert}^{2} - {\vert {J}_{12} \vert}^{2}\end{matrix} ) \\ ( \begin{matrix}{S}_{0} \\ {S}_{1} \\ {S}_{2} \\ {S}_{3}\end{matrix} ) \\ = MS\end{matrix} \qquad ( 13 )$$

As can be seen from equation (13), the Stokes parameters S₀ to S₃ and the Stokes parameters S₀′ to S₃′ have a relationship defined by the three coefficients (third coefficients): Re[J₁₁J₁₂*], Im[J₁₁J₁₂*], and (|J₁₁|²−|J₁₂|²). Equation (13) is a second relation which defines the relationship between the second Fourier coefficients S₀ to S₃ and the first Fourier coefficients S₀′ to S₃′. Re[J₁₁J₁₂*] and Im[J₁₁J₁₂*] are the real part and imaginary part, respectively, of the product [J₁₁J₁₂*] of J₁₁ and the complex conjugate J₁₂* of J₁₂ in the Jones matrix Jₑᵣᵣ describing a manufacturing error attributed to the measurement unit 200b. (|J₁₁|²−|J₁₂|²) is the difference between the absolute values of J₁₁ and J₁₂ in the Jones matrix Jₑᵣᵣ. Of these three coefficients, the real part Re[J₁₁J₁₂*] and the imaginary part Im[J₁₁J₁₂*] are independent coefficients (a first independent coefficient and a second independent coefficient) that are independent of each other. (|J₁₁|²−|J₁₂|²) is a dependent coefficient determined by a combination of the independent coefficients.

Hence, to obtain the Stokes parameters S₀ to S₃ describing the incident light on the measurement unit 200b, the Stokes parameters S₀′ to S₃′ obtained by Fourier-transforming the measured signal can be multiplied by the inverse matrix to the matrix M attributed to a manufacturing error defined by the third coefficients as:

S=M⁻¹S′ (14)

Also, a Stokes parameter S₄′ representing the coefficient of a component, oscillating with a waveform described by cos 2θ, of the signal is given by a first relation:

S₄′={−2Re[J₁₁J₁₂*]S₃+2Im[J₁₁J₁₂*]S₂} (15)

Equation (15) is a relation (first relation) which defines the relationship between the first Fourier coefficient of a component oscillating with a waveform described by cos 2θ and the plurality of second Fourier coefficients using two or more independent coefficients.

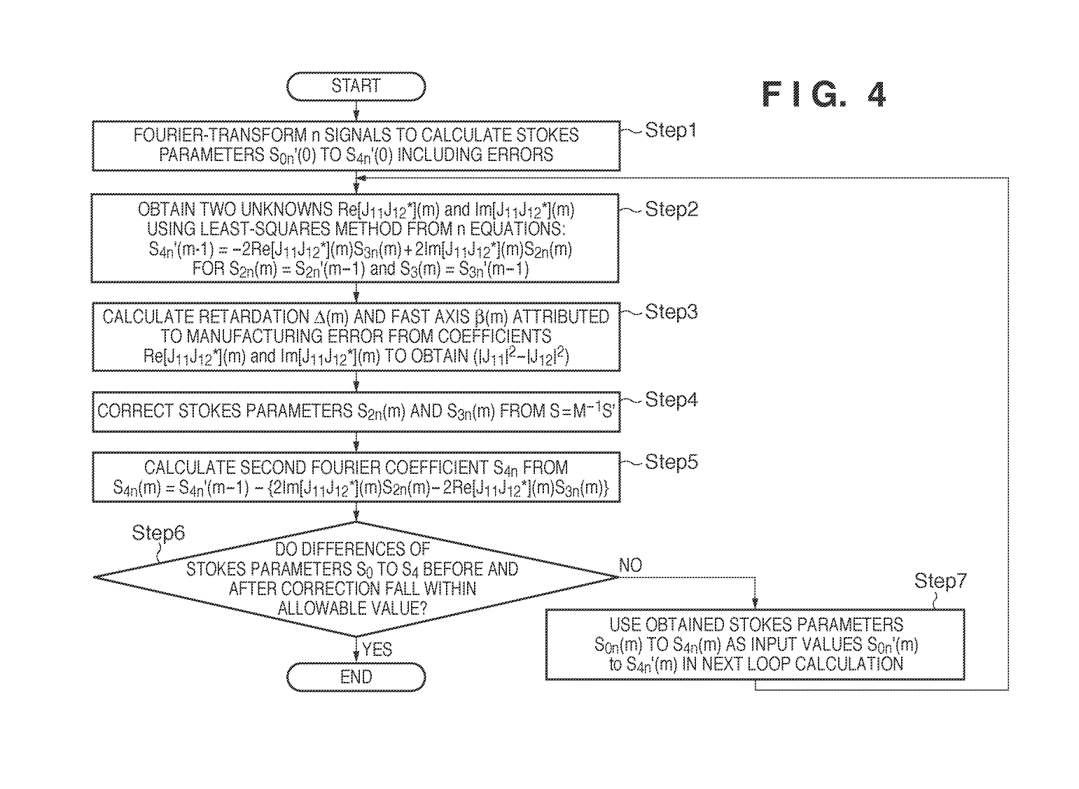

FIG. 4 shows the sequence for obtaining Stokes parameters S₀ to S₃ describing the polarization state of the incident light on the measurement unit 200b with high accuracy by correcting a change in signal due to a manufacturing error of the measurement unit 200b. In Step 1, the measurement apparatus 200 measures signals of n incident polarized light beams with different polarization states, and the calculator 300 Fourier-transforms the signals to calculate Stokes parameters S₀ₙ′(0) to S₃ₙ′(0) and a cos 2θ component S₄ₙ′(0). A number in parentheses indicates the number of times of repeated calculation m, and the second subscript indicates the number of times of measurement n of a plurality of light beams with different polarization states. When n Stokes parameters and n cos 2θ components are substituted into equation (15), and the obtained equations are assembled into a matrix form, we have:

$$( \begin{matrix}{S}_{41}^{′} ( m - 1 ) \\ {S}_{42}^{′} ( m - 1 ) \\ ⋮ \\ {S}_{4 n}^{′} ( m - 1 )\end{matrix} ) = ( \begin{matrix}{S}_{11} ( m ) & {S}_{21} ( m ) & {S}_{31} ( m ) \\ {S}_{12} ( m ) & {S}_{22} ( m ) & {S}_{32} ( m ) \\ ⋮ & ⋮ & ⋮ \\ {S}_{1 n} ( m ) & {S}_{2 n} ( m ) & {S}_{3 n} ( m )\end{matrix} ) ( \begin{matrix}0 \\ 2 Im [ {J}_{11} {J}_{12}^{*} ] ( m ) \\ - 2 Re [ {J}_{11} {J}_{12}^{*} ] ( m )\end{matrix} ) \qquad ( 16 )$$

In Step 2, the calculator 300 substitutes S₂ₙ′(m−1) and S₃ₙ′(m−1) of components oscillating with corresponding oscillation periods for S₂ₙ(m) and S₃ₙ(m), respectively, in equation (16). The calculator 300 obtains two unknowns Re[J₁₁J₁₂*](m) and Im[J₁₁J₁₂*](m) from n equations using the least-squares method (the solution of simultaneous equations if there are two signals). However, the present invention is not limited to calculation using the least-squares method, and an arbitrary regression analysis method may be adopted. For example, the modified Thompson T method may be adopted to eliminate any error which extremely deviates from a normal distribution. The first calculation in repeated calculation is:

$$( \begin{matrix}{S}_{41}^{′} ( 0 ) \\ {S}_{42}^{′} ( 0 ) \\ ⋮ \\ {S}_{4 n}^{′} ( 0 )\end{matrix} ) = ( \begin{matrix}{S}_{11} ( 1 ) & {S}_{21} ( 1 ) & {S}_{31} ( 1 ) \\ {S}_{12} ( 1 ) & {S}_{22} ( 1 ) & {S}_{32} ( 1 ) \\ ⋮ & ⋮ & ⋮ \\ {S}_{1 n} ( 1 ) & {S}_{2 n} ( 1 ) & {S}_{3 n} ( 1 )\end{matrix} ) ( \begin{matrix}0 \\ 2 Im [ {J}_{11} {J}_{12}^{*} ] ( 1 ) \\ - 2 Im [ {J}_{11} {J}_{12}^{*} ] ( 1 )\end{matrix} ) \qquad ( 17 )$$

From the signal measured in Step 1, the cos 2θ components S₄₁′(0) to S₄ₙ′(0) included in the vector on the left-hand side of equation (17) are known. The calculator 300 Fourier-transforms the first to n-th measurement data to obtain a Fourier coefficient S₄′, and determines the Fourier coefficient obtained from the n-th measurement data as S₄ₙ′(0). On the other hand, the Stokes parameters S₁ₙ(1) to S₃ₙ(1) included in the matrix on the right-hand side of equation (17) are obtained by correction in practice, so they are unknown. Thus, in Step 2, two unknowns Re[J₁₁J₁₂*](m) and Im[J₁₁J₁₂*](m) are approximately obtained using, for example, the least-squares method by substituting S₁ₙ′(0) for S₁ₙ(1), S₂ₙ′(0) for S₂ₙ(1), and S₃ₙ′(0) for S₃ₙ(1). The Stokes parameters S₁ₙ′(0) to S₃ₙ′(0) are known from the signal measured in Step 1. The calculator 300 Fourier-transforms the first to n-th measurement data to obtain first Fourier coefficients S₁′ to S₃′, and determines the Fourier coefficients obtained from the n-th measurement data as S₁ₙ′(0), S₂ₙ′(0), and S₃ₙ′(0).

For the number of times of repetition m=2 and subsequent numbers of times of repetition, the calculation is done by substituting S₂ₙ′(m−1) for S₂ₙ(m) and S₃ₙ′(m−1) for S₃ₙ(m) in Step 2. At the time point when the signals are measured, the values (S₀ₙ(m), S₁ₙ(m), S₂ₙ(m), and S₃ₙ(m)) of the Stokes parameters S₀ to S₃ to be obtained are unknown. For this reason, in the first calculation, the differences between S₂ₙ(1) and S₂ₙ′(0) and between S₃ₙ(1) and S₃ₙ′(0) are expected to be relatively large. In contrast, in the second and subsequent calculations, the value corrected upon the previous calculation is used, so the differences between S₂ₙ(m) and S₂ₙ′(m−1) and between S₂ₙ(m) and S₃ₙ′(m−1) gradually reduce. As the calculation is iteratively repeated, the differences between S₂ₙ(m) and S₂ₙ′(m−1) and between S₃ₙ(m) and S₃ₙ′(m−1) eventually reduce to negligible extents. In this manner, repeated calculation makes it possible to obtain Stokes parameters S₀ to S₃ describing the incident light on the measurement unit 200b with high accuracy.

In Step 3, from the obtained correction values for Re[J₁₁J₁₂*](m) and Im[J₁₁J₁₂*](m), the calculator 300 calculates a retardation Δ(m) and a fast axis β(m) of birefringence generated due to a manufacturing error using:

$$Re [ {J}_{11} {J}_{12}^{*} ] = {sin}^{2} ( \frac{Δ}{2} ) sin 2 β cos 2 β \\ Im [ {J}_{11} {J}_{12}^{*} ] = sin ( \frac{Δ}{2} ) cos ( \frac{Δ}{2} ) sin 2 β \qquad ( 18 )$$

Note that we have equations (18) from equation (7).

Solving these simultaneous equations yields two unknowns Δ and β. This calculation may be done analytically or numerically.

Also, from equation (7), we have:

$${\vert {J}_{11} \vert}^{2} - {\vert {J}_{12} \vert}^{2} = {cos}^{2} ( \frac{Δ}{2} ) + {sin}^{2} ( \frac{Δ}{2} ) cos 4 β \qquad ( 19 )$$

The foregoing calculation yields the values of the respective terms of the matrix M in equation (13). When the respective terms of the matrix M are obtained, the Stokes parameters can be corrected using equation (14).

In Step 4, the calculator 300 corrects the Stokes parameters using equation (14) to obtain Stokes parameters S₀ₙ(m) to S₃ₙ(m). This calculation yields Stokes parameters with an accuracy higher than that before the correction.

In Step 5, the calculator 300 calculates a second Fourier coefficient S₄ using a third relation:

S₄n(m)=S₄n′(m−1)−{−2Re[J₁₁J₁₂*](m)S₃n(m)+2Im[J₁₁J₁₂*](m)S₂n(m)} (20)

The third relation can be rewritten as:

S₄=S₄′−{−2Re[J₁₁J₁₂*]S₃+2Im[J₁₁J₁₂*]S₂}

In Step 6, the calculator 300 determines whether to repeat the calculation in accordance with a criterion. One example of the determination criterion is determination as to whether the differences of Stokes parameters before and after correction are equal to or smaller than an allowable value (for example, 0.01 or less). Another example of the determination criterion is determination as to whether the cos 2θ component S₄ₙ(m) calculated by equation (20) is equal to or smaller than an allowable value (for example, 0.01 or less). Still another example of the determination criterion is determination as to whether the amount of non-polarized light is equal to or smaller than an allowable value (for example, 0.01 or less). If the determination criterion is not satisfied, the calculator 300 uses the obtained Stokes parameters S₀ₙ(m) to S₄ₙ(m) as input values S₀ₙ′(m) to S₄ₙ′(m) in the next calculation in Step 7.

From the obtained coefficients Re[J₁₁J₁₂*] and Im[J₁₁J₁₂*], the calculator 300 obtains a retardation Δ and a fast axis β of birefringence generated due to a manufacturing error using equations (18).

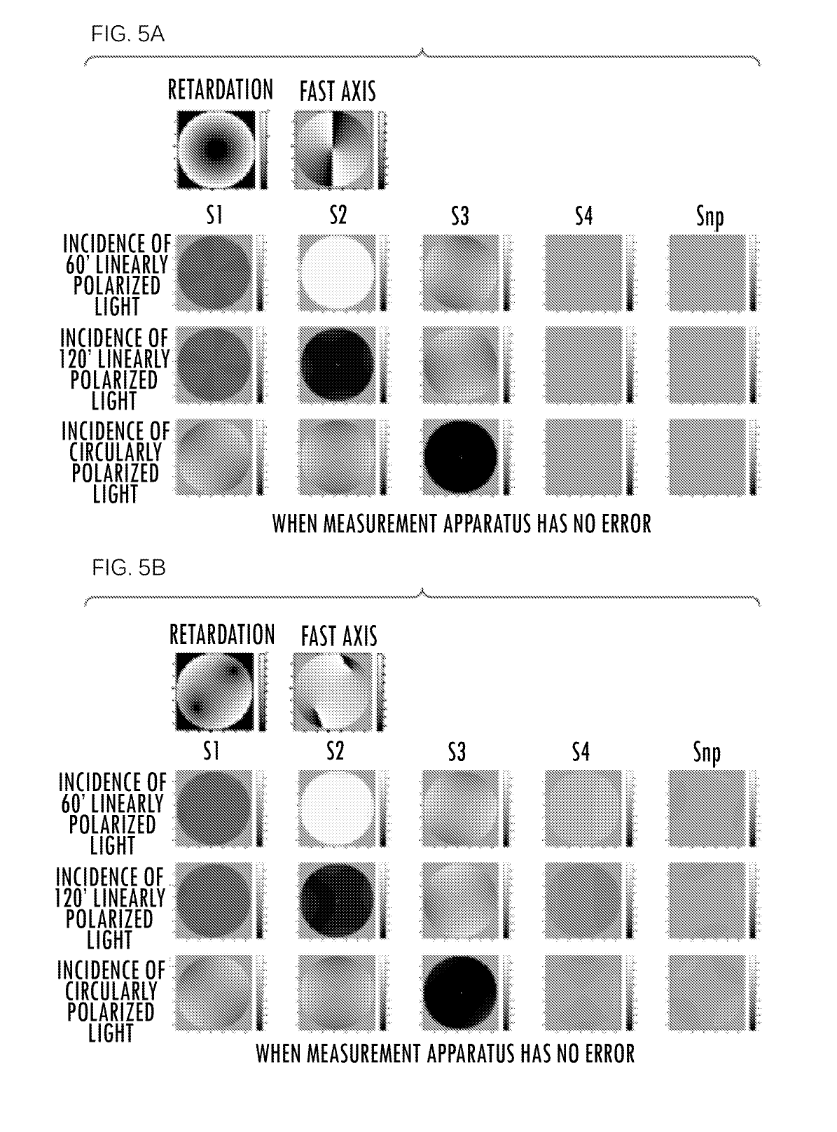

One example of measurement result correction according to the present invention will be given with reference to FIGS. 5 to 7. FIG. 5A depicts the measurement results obtained when the measurement apparatus 200 has no manufacturing error. FIG. 5A shows the results of measuring a measurement object, having a retardation which increases in the radial direction and a radiant fast axis, when three polarized light beams: 60° linearly polarized light, 120° linearly polarized light, and circularly polarized light are incident on the measurement object. When the measurement apparatus 200 has no manufacturing error, a cos 2θ component S₄ and an amount of non-polarized light Sₙₚ are both zero. FIG. 5B depicts the measurement results obtained when the polarizer built in the measurement apparatus 200 is tilted by 0.5° in the 45° direction with respect to both the X- and Y-axes. Like FIG. 5A, FIG. 5B shows the results of measuring a measurement object, having a retardation which increases in the radial direction and a radiant fast axis, when three polarized light beams: 60° linearly polarized light, 120° linearly polarized light, and circularly polarized light are incident on the measurement object. When the polarizer is tilted, the cos 2θ component S₄ and the amount of non-polarized light Sₙₚ are not zero. The values of Stokes parameters S₁ to S₃ have also changed due to the tilt of the polarizer. When the retardation and fast axis of the measurement object are calculated, the obtained results are largely different from the true retardation and fast axis of the measurement object, as shown in FIG. 5B.

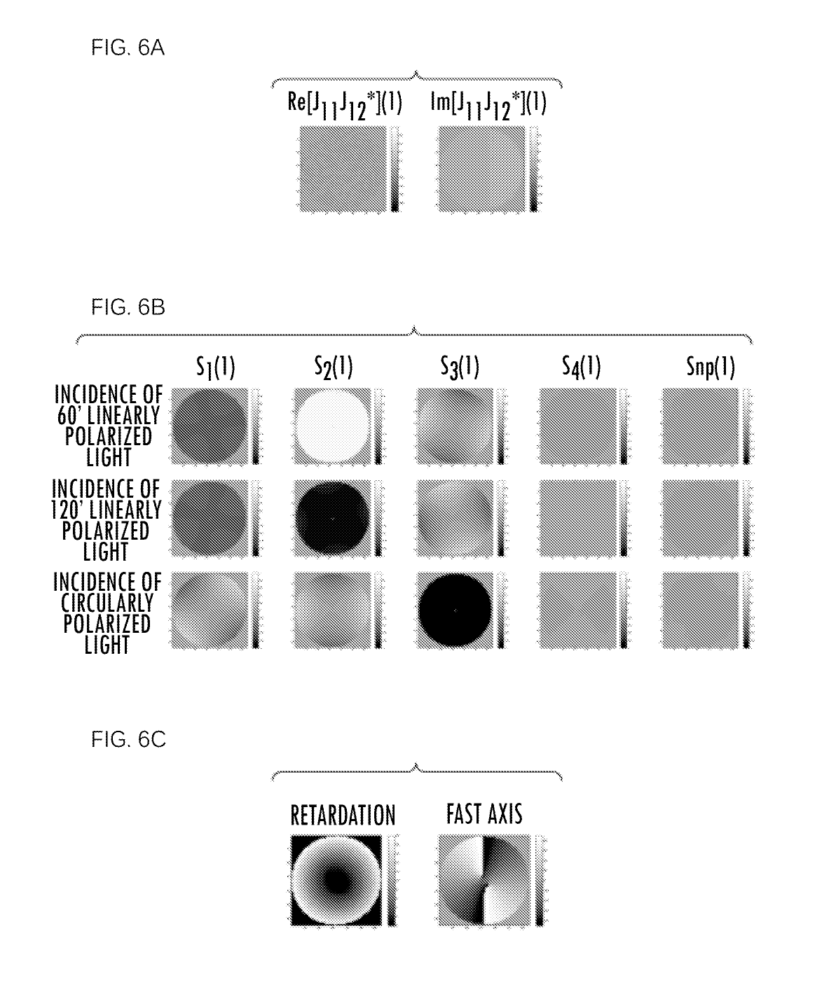

These results are corrected by the sequence shown in FIG. 4. The results of measuring signals of three incident polarized light beams and Fourier-transforming the signals to calculate Stokes parameters S₀ₙ′(0) to S₃ₙ′(0) and a cos 2θ component S₄ₙ′(0) have already been shown in FIG. 5B (Step 1). When the incident polarized light is 60° linearly polarized light, the average of the cos 2θ components within the pupil is 0.195. Two unknowns Re[J₁₁J₁₂*](1) and Im[J₁₁J₁₂*](1) are obtained from three equations using the least-squares method by substituting S₂ₙ′(0) for S₂ₙ(1) and S₃ₙ′(0) for S₃ₙ(1) in equation (17) (Step 2). FIG. 6A shows the calculation results of the coefficients Re[J₁₁J₁₂*](1) and Im[J₁₁J₁₂*](1). A retardation Δ(1) and a fast axis β(1) of birefringence generated due to a manufacturing error are calculated from the obtained coefficients Re[J₁₁J₁₂*](1) and Im[J₁₁J₁₂*](1) using equation (7) (Step 3). This calculation may be done analytically or numerically. The Stokes parameters are corrected using equation (14) (Step 4). A second Fourier coefficient S₄ is calculated using equation (20) (Step 5). FIG. 6B shows corrected Stokes parameters S₁ₙ(1) to S₃ₙ(1), a cos 2θ component S₄ₙ(1), and an amount of non-polarized light Sₙₚₙ(1). When the incident polarized light is 60° linearly polarized light, the average of the cos 2θ components within the pupil decreases to 0.0062 upon the correction.

FIG. 6C shows the retardation and fast axis calculated using the corrected Stokes parameters. As can be seen from a comparison with FIG. 5A, the calculated retardation and fast axis come close to the true values of the measurement object upon the correction. Nevertheless, the fast axis at the pupil center still has an error. It is determined whether to repeat the calculation in accordance with a criterion (Step 6). Note that information as to whether the average, within the pupil, of the cos 2θ components before and after correction is 0.005 or less is used as a determination criterion. In the first correction, the average of the cos 2θ components within the pupil is 0.0062, so repeated calculation is done. The obtained Stokes parameters S₀ₙ(1) to S₄ₙ(1) are used as input values S₀ₙ′(1) to S₄ₙ′(1) in the next calculation (Step 7).

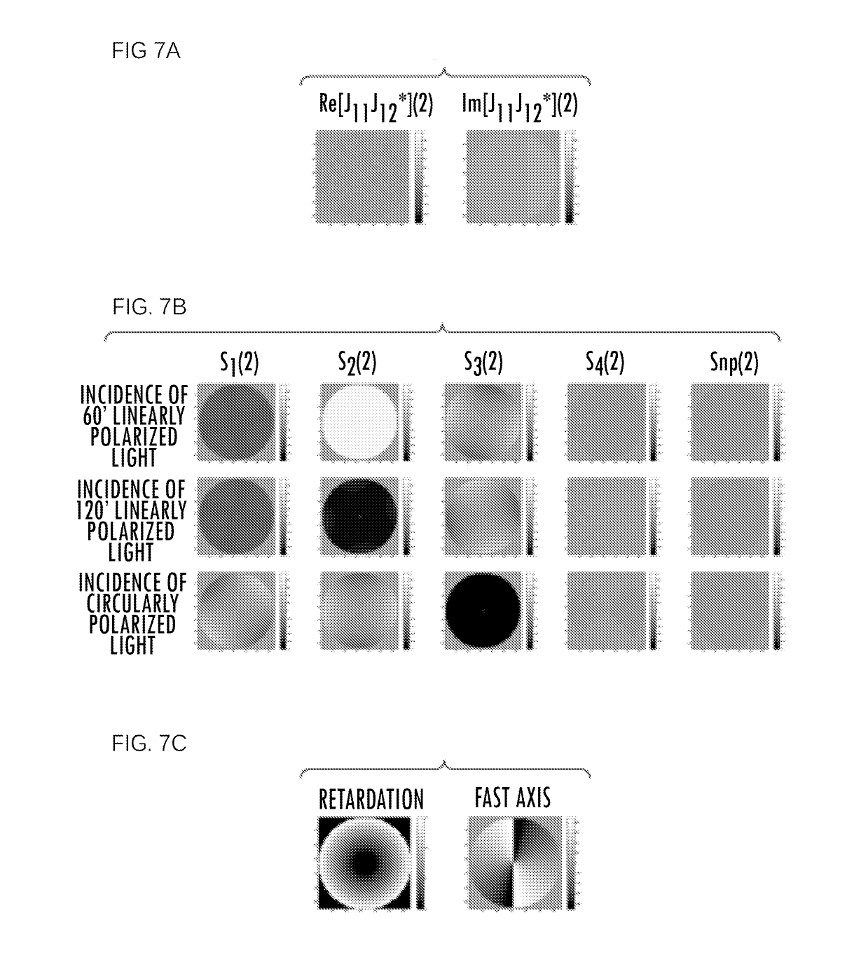

FIGS. 7A to 7C show the calculation results obtained in Steps 2 to 5 again. As shown in FIG. 7B, the cos 2θ components decrease to the degree that their average within the pupil is 0.00021. Also, as shown in FIG. 7C, two times of correction allow the retardation and the fast axis to nearly coincide with those when the measurement apparatus 200 has no error. It is determined whether to repeat the calculation in accordance with a criterion (Step 6). Like the first correction, information as to whether the average of the cos 2θ components before and after correction within the pupil is equal to or smaller than 0.005 is used as a determination criterion. Since the average of the cos 2θ components within the pupil is 0.00021 in the second correction, the repeated calculation ends. In this manner, the true polarization state of a measurement object can be obtained by correcting an error attributed to the measurement apparatus 200 by calculating the error attributed to the measurement apparatus 200 from a plurality of signals and repeating correction by repeated calculation.

In this embodiment, because there are two unknown variables attributed to a manufacturing error, it is necessary to measure at least two signals. To correctly obtain an error, the signals are desirably measured while the incident polarized light has relatively large Stokes parameters S₂ and S₃. This makes it possible to reduce the influence of the signal-to-noise ratio because the cos 2θ component S₄′ becomes relatively large in that case, as is obvious from equation (15). When the Stokes parameters S₂ and S₃ are too small, they themselves are susceptible to the signal-to-noise ratio. Once a matrix M describing the influence of a manufacturing error is calculated, the Stokes parameters can be corrected using equation (14) without subsequent repeated calculation. For example, it is also possible to calculate the matrix M on the outside of the apparatus and register it in the apparatus as a parameter.

### Second Embodiment

The second embodiment is basically the same as the first embodiment except for signal correction calculation. In this embodiment, a relative rotation error α between a waveplate 240 and a polarizer 260 about the optical axis is also corrected using a plurality of measured signals. A case in which the relative rotation origin position between the fast axis of the waveplate 240 and the transmission axis of the polarizer 260 about the optical axis deviates by the angle α due to a manufacturing error will be considered. In this case, a light intensity I detected by a detector 204 is obtained by substituting θ+α for θ in equation (11) as:

$$\begin{matrix}I = \frac{1}{2} {S}_{0}^{′} + \frac{1}{4} {S}_{1}^{′} + \frac{1}{4} {S}_{1}^{′} cos 4 ( θ + α ) + \frac{1}{4} {S}_{2}^{′} sin 4 ( θ + α ) + \\ \frac{1}{2} {S}_{3}^{′} sin 2 ( θ + α ) + \frac{1}{2} {S}_{4}^{′} cos 2 ( θ + α ) \\ = \frac{1}{2} {S}_{0}^{′} \frac{1}{4} {S}_{1}^{′} + \frac{1}{4} ( {S}_{1}^{′} cos 4 α + {S}_{2}^{′} sin 4 α ) cos 4 θ + \\ \frac{1}{4} ( - {S}_{1}^{′} sin 4 α + {S}_{2}^{′} cos 4 α ) sin 4 θ + \\ \frac{1}{2} ( {S}_{3}^{′} cos 2 α - {S}_{4}^{′} sin 2 α ) sin 2 θ + \\ \frac{1}{2} ( {S}_{3}^{′} sin 2 α + {S}_{4}^{′} cos 2 α ) cos 2 θ \\ = \frac{1}{2} {S}_{0}^{″} + \frac{1}{4} {S}_{1}^{″} + \frac{1}{4} {S}_{1}^{″} cos 4 θ + \frac{1}{4} {S}_{2}^{″} sin 4 θ + \\ \frac{1}{2} {S}_{3}^{″} sin 2 θ + \frac{1}{2} {S}_{4}^{″} cos 2 θ\end{matrix} \\ for \\ {S}_{0}^{″} = {S}_{0}^{′} + ( \frac{1}{2} - \frac{1}{2} cos 4 α ) {S}_{1}^{′} - \frac{1}{2} sin 4 α \\ {S}_{1}^{″} = cos 4 {αS}_{1}^{′} + sin 4 α {S}_{2}^{′} \\ {S}_{2}^{″} = - sin 4 {αS}_{1}^{′} + cos 4 α {S}_{2}^{′} \\ {S}_{3}^{″} = cos 2 {αS}_{3}^{′} - sin 2 α {S}_{4}^{′} \\ {S}_{4}^{″} = sin 2 {αS}_{3}^{′} + cos 2 α {S}_{4}^{′} \qquad ( 21 )$$

Hence, the Stokes parameters S₀′, S₁′, S₂′, and S₃′ and the cos 2θ component S₄′ are transformed into Stokes parameters S₀″, S₁″, S₂″, and S₃″ and a cos 2θ component S₄″ as:

$$\begin{matrix}{S}^{″} = ( \begin{matrix}{S}_{0}^{″} \\ {S}_{1}^{″} \\ {S}_{2}^{″} \\ {S}_{3}^{″} \\ {S}_{4}^{″}\end{matrix} ) \\ = ( \begin{matrix}1 & \frac{1}{2} - \frac{1}{2} cos 4 α & - \frac{1}{2} sin 4 α & 0 & 0 \\ 0 & cos 4 α & sin 4 α & 0 & 0 \\ 0 & - sin 4 α & cos 4 α & 0 & 0 \\ 0 & 0 & 0 & cos 2 α & - sin 2 α \\ 0 & 0 & 0 & sin 2 α & cos 2 α\end{matrix} ) \\ ( \begin{matrix}{S}_{0}^{′} \\ {S}_{1}^{′} \\ {S}_{2}^{′} \\ {S}_{3}^{′} \\ {S}_{4}^{′}\end{matrix} ) \\ = {M}^{′} {S}^{′}\end{matrix} \qquad ( 22 )$$

To obtain the Stokes parameters S₀′ to S₄′, the Stokes parameters S₀″ to S₄″ obtained by Fourier-transforming the measured signal can be multiplied by the inverse matrix to the matrix M attributed to a manufacturing error. As can be seen from equation (22), the rotation error α is added as a third independent coefficient which defines the relationship between the first Fourier coefficients S₀″ to S₄″ and first Fourier coefficients S₀′ to S₄′ and, eventually, the second Fourier coefficients S₀ to S₄. Equation (22) establishes a fifth relation which defines the relationship between the second Fourier coefficients S₀ to S₃ and the first Fourier coefficients S₀″ to S₃″ using the coefficients Re[J₁₁J₁₂*], Im[J₁₁J₁₂*], α, and (|J₁₁|²−|J₁₂|²), and can be rewritten as:

S′=M′⁻¹S″ (23)

From equations (22) and (13), the cos 2θ component S₄″ is given by:

$$\begin{matrix}{S}_{4}^{″} = sin 2 α {S}_{3}^{′} + cos 2 α {S}_{4}^{′} \\ = - 2 Im [ {J}_{11} {J}_{12}^{*} ] sin 2 α {S}_{1} + 2 Im [ {J}_{11} {J}_{12}^{*} ] cos 2 α {S}_{2} + \\ \{ ( {\vert {J}_{11} \vert}^{2} - {\vert {J}_{12} \vert}^{2} ) sin 2 α - 2 Re [ {J}_{11} {J}_{12}^{*} ] cos 2 α \} {S}_{3} \\ = a {S}_{1} + {bS}_{2} + {cS}_{3}\end{matrix} \qquad ( 24 )$$

In the first embodiment, to obtain the first independent coefficient Re[J₁₁J₁₂*] and the second independent coefficient Im[J₁₁J₁₂*], a relation: S₄′=−2Re[J₁₁J₁₂*]S₃+2Im[J₁₁J₁₂*]S₂ is used. In contrast, in the second embodiment, to obtain the first independent coefficient Re[J₁₁J₁₂*], the second independent coefficient Im[J₁₁J₁₂*], and the third independent coefficient α, a fourth relation:

S₄″=−2Im[J₁₁J₁₂*] sin 2αS₁+2Im[J₁₁J₁₂*] cos 2αS₂+{(|J₁₁|²−|J₁₂|²)sin 2α−2Re[J₁₁J₁₂*] cos 2α}S₃

is used.

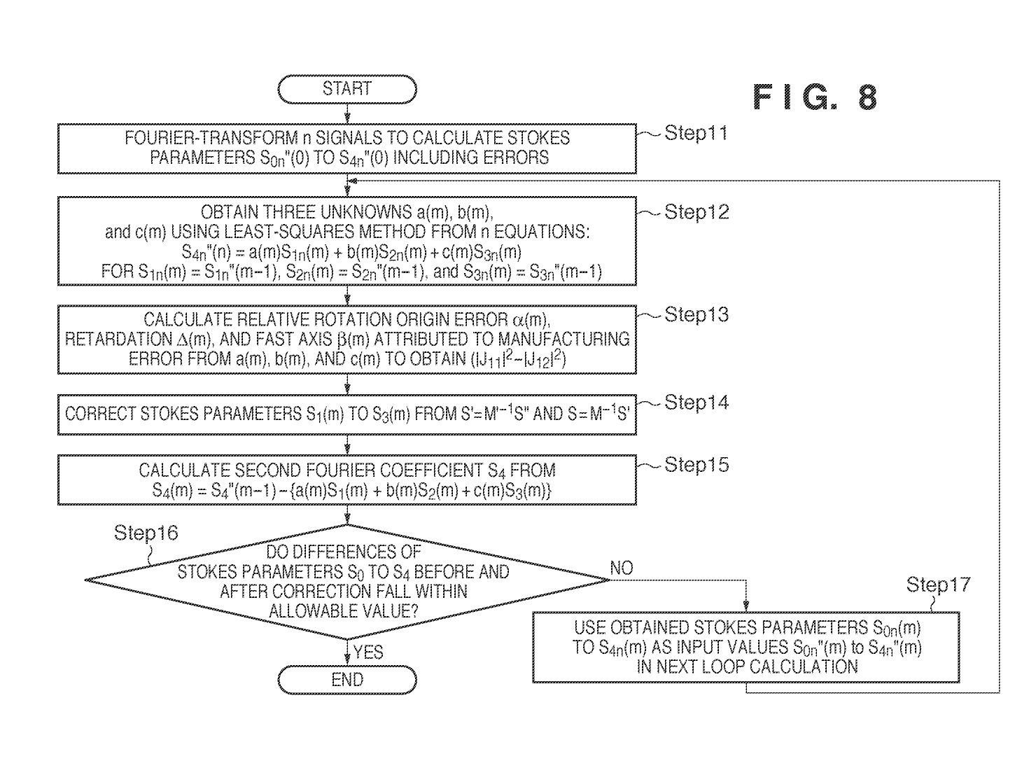

FIG. 8 shows the sequence for obtaining Stokes parameters S₀ to S₃ describing the incident light on the measurement unit 200b with high accuracy by correcting a change in signal due to a manufacturing error of a measurement unit 200b. In Step 11, a measurement apparatus 200 measures signals of n, three or more incident polarized light beams, and a calculator 300 Fourier-transforms the signals to calculate Stokes parameters S₀ₙ″(0) to S₃ₙ″(0) and a first Fourier coefficient S₄ₙ″(0) of a cos 2 θ component. A number in parentheses indicates the number of times of repeated calculation m. When n Stokes parameters and n cos 2θ components are substituted into equation (22), and the obtained equations are assembled into a matrix form, we have:

$$( \begin{matrix}{S}_{41}^{′} ( m - 1 ) \\ {S}_{42}^{′} ( m - 1 ) \\ ⋮ \\ {S}_{4 n}^{′} ( m - 1 )\end{matrix} ) = ( \begin{matrix}{S}_{11} ( m ) & {S}_{21} ( m ) & {S}_{31} ( m ) \\ {S}_{12} ( m ) & {S}_{22} ( m ) & {S}_{32} ( m ) \\ ⋮ & ⋮ & ⋮ \\ {S}_{1 n} ( m ) & {S}_{2 n} ( m ) & {S}_{3 n} ( m )\end{matrix} ) ( \begin{matrix}a ( m ) \\ b ( m ) \\ c ( m )\end{matrix} ) \qquad ( 25 )$$

In Step 12, the calculator 300 substitutes S₁ₙ″(m−1) for S₁ₙ(m), S₂ₙ″(m−1) for S₂ₙ(m), and S₃ₙ″(m−1) for S₃ₙ(m) in equation (25) to obtain three unknowns a(m), b(m), and c(m) from n equations. The calculator 300 uses the least-squares method for the calculation in Step 12 if there are four or more signals, and obtains an exact solution if there are three signals. In Step 13, the calculator 300 calculates a retardation Δ(m) and a fast axis β(m) of birefringence generated due to a manufacturing error, and a relative rotation origin position error α between the waveplate 240 and the polarizer 260 about the optical axis from the obtained values a(m), b(m), and c(m). This calculation may be done analytically or numerically. In Step 14, the calculator 300 corrects the Stokes parameters using equations (23) and (14). In Step 15, the calculator 300 calculates a second Fourier coefficient S₄ using a sixth relation:

S₄(m)=S₄″(m−1)−{a(m)S₁(m)+b(m)S₂(m)+c(m)S₃(m)} (26)

Equation (26) can be rewritten as:

S₄″=S₄−(−2Im[J₁₁J₁₂*] sin 2αS₁+2Im[J₁₁J₁₂*] cos 2θS₂+{(|J₁₁|²−|J₁₂|²)sin 2α−2Re[J₁₁J₁₂*] cos 2α}S₃)

In Step 16, the calculator 300 determines whether to repeat the calculation in accordance with a criterion. Examples of the determination criterion are as described earlier. If the determination criterion is not satisfied, the calculator 300 uses the obtained Stokes parameters S₀ₙ(m) to S₄ₙ(m) as input values S₀ₙ″(m) to S₄ₙ″(m) in the next calculation in Step 17.

In Step 12 of the above-mentioned sequence, the calculator 300 performs the calculation by substituting S₁ₙ″(m−1) for S₁ₙ(m), S₂ₙ″(m−1) for S₂ₙ(m), and S₃ₙ″(m−1) for S₃ₙ(m). At the time point when the signals are measured, the values of the Stokes parameters S₀ to S₃ to be obtained are unknown. For this reason, in the first calculation, the differences between S₁ₙ(1) and S₁ₙ″(0), between S₂ₙ(1) and S₂ₙ″(0), and between S₃ₙ(1) and S₃ₙ″(0) are expected to be relatively large. In contrast, in the second and subsequent calculations, the corrected signals are used, so the differences between S₁ₙ(m) and S₁ₙ″(m−1), between S₂ₙ(m) and 2₃ₙ″(m−1), and between S₃ₙ(m) and S₃ₙ″(m−1) gradually reduce. As the calculation is iteratively repeated, the differences between S₁ₙ(m) and S₁ₙ″(m−1), between S₂ₙ(m) and S₂ₙ″(m−1), and between S₃ₙ(m) and S₃ₙ″(m−1) eventually reduce to negligible extents. In this manner, repeated calculation makes it possible to obtain Stokes parameters describing the incident light on the measurement unit 200b with high accuracy.

In this embodiment, because there are three unknown variables attributed to a manufacturing error, it is necessary to measure at least three signals. To correctly obtain an error, the signals are desirably measured while the incident polarized light has relatively large Stokes parameters S₁, S₂, and S₃. This is because when the Stokes parameters S₁, S₂, and S₃ are too small, their values are susceptible to the signal-to-noise ratio. Once matrices M and M′ describing the influence of a manufacturing error are calculated, the Stokes parameters can be corrected using equations (14) and (23) without subsequent repeated calculation. For example, it is also possible to calculate the matrices M and M′ on the outside of the apparatus and register them in the apparatus as parameters.

### Third Embodiment

The third embodiment is basically the same as the first and second embodiments except that in the former a measurement apparatus 200 is mechanically adjusted so as to reduce the calculated measurement error instead of correcting the measurement result by calculation. When the measurement values of Stokes parameters have errors due to the tilt of a polarizer 260 with respect to the optical axis, it is also possible to reduce the measurement errors by adjusting the tilt of the polarizer 260. In this embodiment, a calculator 300 is connected to a driving unit 60. The calculator 300 calculates the tilt amount and tilt direction of the polarizer 260. The obtained pieces of information are sent to the driving unit 60, and the tilt of the polarizer 260 is adjusted.

### Fourth Embodiment

The fourth embodiment is basically the same as the first and second embodiments except that in the former a measurement apparatus 200 is mechanically adjusted instead of correcting the measurement result by calculation. The rotation origin positions of a waveplate 240 and polarizer 260 about the optical axis can also be corrected by mechanically adjusting them instead of correcting them by calculation. In this embodiment, a calculator 300 is connected to a driving unit 60. The calculator 300 calculates errors associated with the rotation origin positions of the waveplate 240 and polarizer 260 about the optical axis. The obtained pieces of information are sent to the driving unit 60, and the rotation origin positions of the waveplate 240 and polarizer 260 about the optical axis are adjusted.

In this manner, the measurement apparatus 200 according to each embodiment can measure the polarization state of light with high accuracy by reducing an influence that manufacturing errors of the measurement apparatus 200 exert on the measurement result. Also, using the measurement apparatus 200 which measures the polarization state of light with high accuracy, an exposure apparatus according to the embodiment can perform satisfactory exposure under appropriate illumination conditions by illuminating a reticle 11 and a wafer (photosensitive substrate) 14 with light having a desired polarization state. That is, in each embodiment, it is possible to measure the polarization state of illumination light on the reticle 11 using the measurement apparatus 200, and accurately determine whether the illumination light has an appropriate polarization state. If the illumination light on the reticle 11 has an inappropriate polarization state, it is possible to realize a desired polarization state (including a non-polarized state) by appropriate optical adjustment in, for example, a controller. As a result, the exposure apparatus can perform satisfactory exposure under appropriate illumination conditions by illuminating the reticle 11 with light having a desired polarization state.

[Method of Manufacturing Device]

A method of manufacturing a device using the above-mentioned exposure apparatus will be described next. In this case, the device is manufactured by a step of exposing a substrate using the above-mentioned exposure apparatus, a step of developing the exposed substrate, and other known steps. The device can be, for example, a semiconductor integrated circuit device or a liquid crystal display device. The substrate can be, for example, a wafer or a glass plate. The known steps include, for example, oxidation, film formation, vapor deposition, doping, planarization, dicing, bonding, and packaging steps.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-156323, filed Jun. 30, 2009, which is hereby incorporated by reference herein in its entirety.

What is claimed is:

1. A measurement apparatus which comprises an optical system including a waveplate that changes a polarization state of light, and a polarizer that selectively transmits a specific polarization component of the light having passed through the waveplate, a detector that detects an intensity of the light having passed through the waveplate and the polarizer, and a calculator, and which measures a polarization state of a light beam to be measured that is incident on the optical system, wherein
the calculator is configured to
Fourier-transform changes in intensity of a plurality of light beams with different polarization states, which are detected by the detector while changing a relative rotation angle θ between the waveplate and the polarizer about an optical axis, to calculate values of a plurality of Fourier coefficients that are coefficients of respective components oscillating with waveforms described by cos 4θ, sin 4θ, sin 2θ, and cos 2θ,
approximately calculate, using the values of the first Fourier coefficients, a plurality of third coefficients that are coefficients which define a relationship between the plurality of first Fourier coefficients and a plurality of second Fourier coefficients that are coefficients of the respective components oscillating with waveforms described by cos 4θ, sin 4θ, and sin 2θ in a Fourier transform of a change in intensity of light, which is detected by the detector while changing a relative rotation angle between the waveplate and the polarizer about the optical axis assuming that the detection result contains no measurement error attributed to the optical system, and
calculate a measurement error attributed to the optical system using the plurality of third coefficients,
the plurality of third coefficients include not less than two independent coefficients independent of each other, and a dependent coefficient determined by a combination of the not less than two independent coefficients, and
in a relation which defines a relationship between the first Fourier coefficient of the component oscillating with a waveform described by cos 2θ and the plurality of second Fourier coefficients, the calculator substitutes a value of the first Fourier coefficient of the component oscillating with a waveform described by cos 2θ, calculated for each of the plurality of light beams, for the first Fourier coefficient of the component oscillating with a waveform described by cos 2θ, and substitutes values of the first Fourier coefficients of the components oscillating with respective oscillation periods, calculated for each of the plurality of light beams, for the plurality of second Fourier coefficients of the components oscillating with the corresponding oscillation periods to calculate the not less than two independent coefficients, and calculates the dependent coefficient from the not less than two calculated independent coefficients.

2. The apparatus according to claim 1, wherein
letting S₂′, S₃′, and S₄′ be the first Fourier coefficients of the components oscillating with waveforms described by sin 4θ, sin 2θ, and cos 2θ, respectively, S₂ and S₃ be the second Fourier coefficients of the components oscillating with waveforms described by sin 4θ and sin 2θ, respectively,
$${J}_{err} = ( \begin{matrix}{J}_{11} & {J}_{12} \\ {J}_{21} & {J}_{22}\end{matrix} )$$
be a Jones matrix describing a manufacturing error attributed to the optical system, and [J₁₁J₁₂*] be a product of J₁₁ and a complex conjugate J₁₂* of J₁₂,
the not less than two independent coefficients include a first independent coefficient represented by a real part Re[J₁₁J₁₂*] of the product, and a second independent coefficient represented by an imaginary part Im[J₁₁J₁₂*] of the product,
the relationship between the first Fourier coefficient of the component oscillating with a waveform described by cos 2θ and the plurality of second Fourier coefficients is given by a first relation: S₄′=−2Re[J₁₁J₁₂*]S₃+2Im[J₁₁J₁₂*]S₂,
the measurement error attributed to the optical system includes a retardation Δ and a fast axis β of birefringence attributed to the optical system, and
the calculator
calculates the first independent coefficient Re[J₁₁J₁₂*] and the second independent coefficient Im[J₁₁J₁₂*] by substituting values of the first Fourier coefficients S₂′, S₃′, and S₄′, calculated for not less than two light beams with different polarization states, for the Fourier coefficients S₂, S₃, and S₄′, respectively, in the first relation: S₄′=−2Re[J₁₁J₁₂*]S₃+2Im[J₁₁J₁₂*]S₂, and
calculates the retardation Δ and the fast axis β of the birefringence attributed to the optical system by substituting the calculated first independent coefficient Re[J₁₁J₁₂*] and second independent coefficient Im[J₁₁J₁₂*] into:
$$Re [ {J}_{11} {J}_{12}^{*} ] = {sin}^{2} ( \frac{Δ}{2} ) sin 2 β cos 2 β$$
$$Im [ {J}_{11} {J}_{12}^{*} ] = sin ( \frac{Δ}{2} ) cos ( \frac{Δ}{2} ) sin 2 β$$

3. The apparatus according to claim 2, wherein
the dependent coefficient is (|J₁₁|²−|J₁₂|²) and is calculated by substituting the retardation Δ and the fast axis β of the birefringence attributed to the optical system into:
$${\vert {J}_{11} \vert}^{2} - {\vert {J}_{12} \vert}^{2} = {cos}^{2} ( \frac{Δ}{2} ) + {sin}^{2} ( \frac{Δ}{2} ) cos 4 β$$
and letting S₀′ and S₁′ be a first Fourier coefficient of a non-oscillating component and the first Fourier coefficient of the component oscillating with a waveform described by cos 4θ, and S₀ and S₁ be a second Fourier coefficient of the non-oscillating component and the second Fourier coefficient of the component oscillating with a waveform described by cos 4θ,
the calculator repeats
calculating values of the second Fourier coefficients S₀ to S₃ using a second relation which defines a relationship between the second Fourier coefficients S₀ to S₃ and the first Fourier coefficients S₀′ to S₃′ using the first independent coefficient Re[J₁₁J₁₂*], the second independent coefficient Im[J₁₁J₁₂*], and the dependent coefficient (|J₁₁|²−|J₁₂|²), values of the first Fourier coefficients S₀′ to S₃′, the first independent coefficient Re[J₁₁J₁₂*], the second independent coefficient Im[J₁₁J₁₂*], and the dependent coefficient (|J₁₁|²−|J₁₂|²), and calculating a second Fourier coefficient S₄ by a third relation: S₄=S₄′−{−2Re[J₁₁J₁₂*]S₃+2Im[J₁₁J₁₂*]S₂}, and
calculating correction values for the first independent coefficient Re[J₁₁J₁₂*] and the second independent coefficient Im[J₁₁J₁₂*] by substituting the values of the second Fourier coefficients S₂, S₃, and S₄ of the calculated second Fourier coefficients for the Fourier coefficients S₂, S₃, and S₄′, respectively, in the first relation.

4. The apparatus according to claim 1, wherein
letting S₁″, S₂″, S₃″, and S₄″ be the first Fourier coefficients of the components oscillating with waveforms described by cos 4θ, sin 4θ, sin 2θ, and cos 2θ, respectively, S₁, S₂, and S₃ be the second Fourier coefficients of the components oscillating with waveforms described by cos 4θ, sin 4θ, and sin 2θ, respectively,
$${J}_{err} = ( \begin{matrix}{J}_{11} & {J}_{12} \\ {J}_{21} & {J}_{22}\end{matrix} )$$
be a Jones matrix describing a manufacturing error attributed to the optical system, and [J₁₁J₁₂*] be a product of J₁₁ and a complex conjugate J₁₂* of J₁₂,
the not less than two independent coefficients include a first independent coefficient represented by a real part Re[J₁₁J₁₂*] of the product, a second independent coefficient represented by an imaginary part Im[J₁₁J₁₂*] of the product, and a third independent coefficient represented by a relative rotation error α between a fast axis of the waveplate and a transmission axis of the polarizer about an optical axis, and the dependent coefficient includes (|J₁₁|²−|J₁₂|²),
the relationship between the first Fourier coefficient of the component oscillating with a waveform described by cos 2θ and the second Fourier coefficients is given by a fourth relation: S₄″=−2Im[J₁₁J₁₂*] sin 2αS₁+2Im[J₁₁J₁₂*] cos 2αS₂+{(|J₁₁|²−|J₁₂|²)sin 2α−2Re[J₁₁J₁₂*] cos 2α}S₃,
the measurement error attributed to the optical system includes a retardation Δ and a fast axis β of birefringence attributed to the optical system, and the relative rotation error α about the optical axis, and
the calculator
calculates the first independent coefficient Re[J₁₁J₁₂*], the second independent coefficient Im[J₁₁J₁₂*], and the third independent coefficient α by substituting values of the first Fourier coefficients S₁″, S₂″, S₃″, and S₄″, calculated for not less than three light beams with different polarization states, for the Fourier coefficients S₁, S₂, S₃, and S₄″, respectively, in the fourth relation, and
calculates the retardation Δ and the fast axis β of the birefringence attributed to the optical system by substituting the calculated first independent coefficient Re[J₁₁J₁₂*] and second independent coefficient Im[J₁₁J₁₂*] into:
$$Re [ {J}_{11} {J}_{12}^{*} ] = {sin}^{2} ( \frac{Δ}{2} ) sin 2 β cos 2 β$$
$$Im [ {J}_{11} {J}_{12}^{*} ] = sin ( \frac{Δ}{2} ) cos ( \frac{Δ}{2} ) sin 2 β$$

5. The apparatus according to claim 4, wherein
letting S₀″ be a first Fourier coefficient of a non-oscillating component, and S₀ be a second Fourier coefficient of the non-oscillating component,
the calculator repeats
calculating values of the second Fourier coefficients S₀ to S₃ using a fifth relation which defines a relationship between the second Fourier coefficients S₀ to S₃ and the first Fourier coefficients S₀″ to S₃″ using the first independent coefficient Re[J₁₁J₁₂*], the second independent coefficient Im[J₁₁J₁₂*], the third independent coefficient α, and the dependent coefficient (|J₁₁|²−|J₁₂|²), values of the first Fourier coefficients S₀″ to S₄″, the first independent coefficient Re[J₁₁J₁₂*], the second independent coefficient Im[J₁₁J₁₂*], the third independent coefficient α, and the dependent coefficient (|J₁₁|²−J₁₂|²), and calculating a second Fourier coefficient S₄ by a sixth relation: S₄″=S₄−(−2Im[J₁₁J₁₂*] sin 2αS₁+2Im[J₁₁J₁₂*] cos 2αS₂+{(|J₁₁|²−|J₁₂|²)sin 2α−2Re[J₁₁J₁₂*] cos 2α}S₃), and
calculating correction values for the first independent coefficient Re[J₁₁J₁₂*], the second independent coefficient Im[J₁₁J₁₂*], and the third independent coefficient α by substituting the values of the second Fourier coefficients S₁, S₂, S₃, and S₄ of the calculated second Fourier coefficients for the Fourier coefficients S₁, S₂, S₃, and S₄″, respectively, in the fourth relation: S₄″=−2Im[J₁₁J₁₂*] sin 2αS₁+2Im[J₁₁J₁₂*] cos 2αS₂+{(|J₁₁|²−|J₁₂|²)sin 2α−2Re[J₁₁J₁₂*] cos 2α}S₃.

6. The apparatus according to claim 1, wherein the measurement error includes at least one of a measurement error attributed to a tilt of the polarizer with respect to the optical axis of the polarizer, a measurement error attributed to stress birefringence generated upon holding the polarizer, and a measurement error attributed to birefringence of a glass material which forms the polarizer.

7. The apparatus according to claim 1, wherein the calculator corrects, the measurement result of the polarization state of the light beam to be measured, using the calculated measurement error.

8. The apparatus according to claim 1, further comprising
a driving unit,
wherein said driving unit adjusts at least one of a tilt of the polarizer with respect to the optical axis of the waveplate and the polarizer and a relative rotation origin position between the waveplate and the polarizer so as to reduce the calculated measurement error.

9. An exposure apparatus which exposes a substrate via a pattern formed on a reticle, the apparatus comprising
a measurement apparatus defined in claim 1, which is configured to measure a polarization state of illumination light on at least one of the reticle and the substrate.

10. The apparatus according to claim 9, further comprising
a controller configured to control the polarization state of the illumination light based on the measurement result obtained by said measurement apparatus.
